(19) United States
(12) Patent Application Publication
(10) Pub. No.: US 2016/0332531 A1
(43) Pub. Date: Nov. 17, 2016

(54) METHOD FOR MANAGING A STATE OF CHARGE OF A BATTERY

(71) Applicant: RENAULT s.a.s., Boulogne-Billancourt (FR)

(72) Inventors: Yann CHAZAL, Paris (FR); Do-Hieu TRINH, Fontenay Le Fleury (FR); Philippe TOUSAINT, Versailles (FR); Mathieu UMLAWSKI, Versailles (FR)

(73) Assignee: RENAULT s.a.s., Boulogne-Billancourt (FR)

(21) Appl. No.: 15/111,404

(22) PCT Filed: Jan. 15, 2015
(86) PCT No.: PCT/FR2015/050090

§ 371 Date: Jul. 13, 2016

(30) Foreign Application Priority Data
Jan. 20, 2014 (FR) 1450420

(51) Int. Cl. B60L 11/18

(52) U.S. Cl. CPC B60L 11/1862; B60L 11/1857; B60L 11/187

(57) ABSTRACT

A method for managing a state of charge of a battery connected for supplying a power distribution network includes estimating a range of values of the state of charge of the battery minimizing a state of aging of the battery, charging or discharging the battery so as to reach an optimum value of state of charge included within the range of values, and prior to the estimating, detecting a state of non-use of the battery during which the battery is neither charged nor discharged.

### FIELD OF THE INVENTION

The invention relates to a method for managing a state of charge of a battery connected for supplying a power distribution network.

This invention may be applied irrespective of the type of battery and may be extended non-exclusively to vehicles. In particular, the invention is particularly advantageously applicable to managing the state of charge of a plurality of batteries connected for supplying a power distribution network so as to maximize their residual capacities.

### PRIOR ART

In the field, methods are known for managing a state of charge of a battery connected for supplying a power distribution network. These methods comprise the following steps:
estimate a range of values of said state of charge of the battery minimizing the state of aging of the battery,
charge or discharge the battery so as to reach a value of state of charge included within said range of values.

One such example is disclosed in US2012/0249048 which describes a solution in which the state of aging of the battery is limited by operating the batteries, both in charging and in discharging, within a range of values of the state of charge included between two values.

It has been observed that the invention described in US2012/0249048 suffers from the drawback of not taking into account all the elements needed for minimizing the state of aging of the battery. A fixed range of values is disclosed, which is not optimal in order to minimize the state of aging of the battery. For example, during a long period when the battery is unused, the battery may remain at a sub-optimal value of state of charge, in the sense that there exist other values of state of charge that would degrade the battery to a lesser extent.

### SUBJECT OF THE INVENTION

In this context, the problem posed here is to optimize the management of the state of charge of a battery. In particular, the aim is to minimize the degradation of the battery over time. Another objective is the optimization of the choices of the ranges of value of the state of charge of the battery by taking into account the operating state of the battery; in particular, the present invention aims to take into account the operating state of the battery, such as its state of charge or discharge, or periods of non-use of the battery (periods during which the battery is neither charged nor discharged, but can self-discharge). Yet another aim is the optimization of the ranges of value of the state of charge of the battery as a function of the operating temperature of the battery and/or of the ambient temperature in order to minimize the state of aging of the battery.

For this purpose, one subject of the invention is notably a method for managing a state of charge of a battery connected for supplying a power distribution network. The method comprises a step for estimating a range of values of said state of charge minimizing the state of aging of the battery. It also comprises a step for charging or for discharging the battery so as to reach an optimum value of state of charge included within said range of values. The method according to the invention is characterized in that it comprises, advantageously, a preliminary step for detecting a state of non-use of the battery, during which the battery is neither charged nor discharged.

This solution allows the aforementioned problems to be overcome.

In particular, the detection of the state of non-use of the battery allows the battery to be placed under favorable conditions minimizing its state of aging when the battery is not being used.

In one embodiment, during the preliminary step, the expiration of a predetermined period during which the battery is in the state of non-use is detected.

In one embodiment, the range of values of said state of charge of the battery minimizing the state of aging of the battery is defined by a first minimum value and a second maximum value which vary as a function of a temperature associated with the battery.

In one embodiment, the temperature associated with the battery is an operating temperature of the battery.

In one embodiment, the temperature associated with the battery is an ambient temperature of a housing in which the battery is installed.

In one embodiment, a step allows the temperature associated with the battery to be estimated based on said ambient temperature and information relating to the operation of the battery.

In one embodiment, for a range of operating temperature of the battery included between 10° C. and 25° C.:
the first value is equal to 10%, and,
the second value is equal to 70%.

In one embodiment, for an operating temperature of the battery substantially equal to 45° C.:
the first value is equal to 50%, and,
the second value is equal to 70%.

In one embodiment, for an operating temperature of the battery substantially equal to 55° C.:
the first value is equal to 50%, and,
the second value is equal to 70%.

In one embodiment, the method comprises the following preliminary steps:
measure the state of charge of a plurality of batteries,
select a battery from amongst said plurality of batteries.

In one embodiment, an additional step allows the state of aging of a battery to be determined by collecting information relating to physical quantities of the battery.

A second subject of the invention is also targeted, in which a system for managing a state of charge of a battery comprises means for implementing the method according to any one of the preceding embodiments.

### BRIEF DESCRIPTION OF THE FIGURES

FIG. 1 shows one example of an architecture of the stationary storage system.

FIG. 2 shows a diagram illustrating one example of a management method according to the invention.

FIG. 3 shows a diagram illustrating another example of a management method according to the invention.

FIG. 4 shows a curve representing the variation of the coefficient of degradation of the battery (i.e. its state of aging) as a function of the state of charge of the battery over a range of operating temperatures of the battery in the range between 10° C. and 25° C.

FIG. 5 shows a curve representing the variation of the coefficient of degradation of the battery (i.e. its state of aging) as a function of the state of charge of the battery for an operating temperature of the battery substantially equal to 45° C.

FIG. 6 shows a curve representing the variation of the coefficient of degradation of the battery (i.e. its state of aging) as a function of the state of charge of the battery for an operating temperature of the battery substantially equal to 55° C.

### DESCRIPTION OF EXEMPLARY EMBODIMENTS OF THE INVENTION

Depending on its aging, the performance characteristics of the battery 50 may vary significantly during its use. A stationary storage system 56 monitors this information. The main function of the stationary storage system 56 is to implement the management of the information on the state of each battery 50 composing the plurality of batteries 50 in order to enable the maximum use of the energy capacities of the plurality of batteries 50 while at the same time minimizing the state of aging of the battery 50.

Conventionally, the stationary storage system is capable of collecting, via a step 20, information relating to physical quantities for determining the state of aging of a battery, of the following type (non-exhaustive list):
the operating temperature at different points in the battery,
the current and the total voltage of the battery,
the voltage of each cell of the battery,
the state of charge of the battery,
the available energy remaining in discharge mode, the power available in discharge mode.

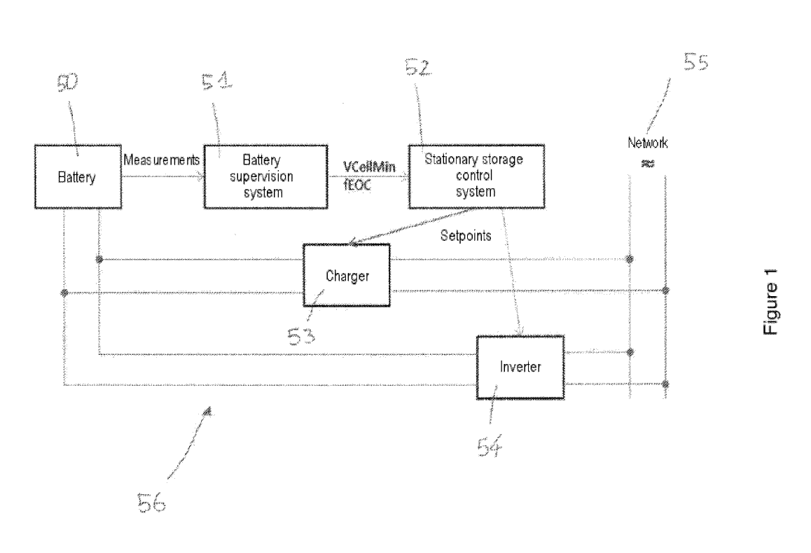

As shown in FIG. 1, the stationary storage system 56 for the residual capacities of a plurality of batteries 50 comprises the following elements:
a battery 50,
a system 51 for supervising the battery,
a stationary storage control system 52,
a charger 53,
an inverter 54.

These elements form the stationary storage system 56. This stationary storage system 56 is connected to the AC current supply network 55.

The system 51 for supervising the battery 50 carries out the acquisition of physical quantities of the battery (measurements of temperatures, voltages on each of the cells, current, etc.). These physical quantities notably have the function of determining the state of aging of the battery 50. The system 51 for supervising the battery 50 performs calculations based on these measurements in order, for example, to determine:
a minimum voltage for the cells V_{cellMin;}
a first binary value indicating whether the charging has finished f_{EOC}=1 or f_{EOC}=0;
a charging power P_{CHG,HVB} or a discharge power P_{DCHG,HVB} that the battery 50 can handle without damage;
a voltage V_{HVB} and a current I_{HVB} measured across the terminals of the battery 50;
a quantity of energy E_{HVB} available from the battery 50.

The system 51 for supervising the battery 50 communicates the physical quantities allowing the state of aging of the battery 50 to be determined to the stationary storage control system 52. The system 51 for supervising the battery 50 notably allows a step 70 for measuring the operating temperature of the battery 50 to be carried out.

The stationary storage control system 52 is subject to certain energy constraints. For example, the stationary storage control system 52 may request to charge the battery 50 during the off-peak periods and to discharge it during the peak periods.

As shown in FIG. 1, the stationary storage control system 52 establishes charge or discharge setpoints as a function of the information that it receives and of its energy constraints. The setpoints are sent to the charger 53 or the inverter 54 in order to be applied: the battery 50 is charged or discharged accordingly.

According to the invention, the method for managing a state of charge SOC of a battery 50 connected for supplying a power distribution network 55 comprises the following steps:
detect 120 a state of non-use of the battery during which the battery is neither charged nor discharged,
estimate 100 a range of values of said state of charge of the battery minimizing the state of aging of the battery,
charge or discharge 110 the battery so as to reach an optimum value of state of charge included within said range of values.

The preliminary step 120 including the detection of a state of non-use of the battery during which the battery is neither charged nor discharged, may for example detect the expiration of a predetermined period during which the battery is in the state of non-use. This preliminary step advantageously allows the battery to be placed under conditions minimizing its degradation over time. The state of non-use of a battery is a state in which the battery is particularly vulnerable, which is why charging or discharging the battery in order to reach a value included within the range of values minimizing its state of aging allows said battery to be preserved. In the absence of active use, the battery 50 should therefore be set as often as possible in a state of charge SOC limiting this degradation. In the case of an active use (in a state of use), the battery 50 will typically be able to charge up or be discharged without taking into account said range of values minimizing the state of aging of the battery 50. While waiting for a setpoint requesting it to exploit the storage system 56, the stationary storage control system 52 is free to decide on the level of charge to which each battery 50 is to be set.

Furthermore, the invention is also aimed at a method for managing a state of charge of a plurality of batteries connected together for supplying an electrical power distribution network 55, this method comprising a storage phase for storing in the plurality of batteries 50 energy coming from the supply network 55 and an energy release phase for discharging the energy into the supply network 55. It will therefore be understood that the step 110 for charging the battery 50 corresponds to the storage phase for storing energy coming from the supply network 55 in the plurality of batteries and the discharge of the battery 50 corresponds to the energy release phase for discharging the energy into the supply network 55. While waiting for a setpoint requesting it to exploit the storage system 56, the stationary storage control system 52 is free to decide on the level of charge at which each battery 50 is to be set. Thus, when the method for managing the state of charge of the plurality of batteries is neither in the storage phase nor in the energy release phase, then the plurality of batteries 50 is considered as being in a state of non-use, in other words the storage system 56 is not being used.

Amongst the factors influencing the state of aging of a battery 50, there is the temperature. In a context of use in a stationary storage system 56 comprising a plurality of batteries 50, the latter are conventionally localized in narrow enclosed housings, such as for example technical rooms. As a consequence, the ambient temperature of a housing in which the battery 50 is connected for supplying a power distribution network 55 varies as a function of parameters such as the geographical position of the housing in question, the position of the housing within the building, etc. Moreover, for the same housing, the ambient temperature can vary over time depending on exposure to the sun, the season, etc. Finally, the use of such a stationary storage system 56 will generate heat and have an influence on the ambient temperature of the room. In view of the impact of the temperature on the state of aging of a battery 50, the step 120 including detecting the state of non-use of the battery is particularly advantageous because it allows parameters able to be used to bring the battery 50 into the range of values of the state of charge minimizing the state of aging of the battery to be updated.

In another embodiment, the range of values comprises a first minimum value SOC1 and a second maximum value SOC2 which vary as a function of a temperature T associated with the battery 50, according to a relationship SOC₁=f₁(T), respectively SOC2=f₂(T). This advantageously allows the degradation of the battery 50 over time, having an impact on the state of aging of the battery 50, to be minimized. The temperature associated with the battery may be an ambient temperature of a housing in which the battery 50 is installed or an operating temperature of the battery.

In one embodiment, a step 60 is thus provided for measuring the ambient temperature of the housing in which the battery 50 is installed. Alternatively, it is possible to carry out a step 70 for measuring the operating temperature of the battery 50.

In another embodiment of the invention, a step 80 is provided for estimating the temperature T associated with the battery 50 based on the ambient temperature and on information relating to the operation of the battery. The step 65 including the gathering of information relating to the operation of the battery may for example correspond to an interval of time during which the battery is neither charged nor discharged.

The first value SOC1 and the second value SOC2 may result from a step 90 during which the first value SOC1 and the second value SOC2 are calculated as a function of the operating temperature of the battery and of the ambient temperature of a housing in which the battery 50 is connected for supplying a power distribution network 55. Alternatively, the first value SOC1 and the second value SOC2 are calculated during the step 90 solely as a function of the operating temperature of the battery. According to another alternative, the first value SOC1 and the second value SOC2 are calculated during the step 90 as a function of the ambient temperature.

Aside from the ambient temperature of the housing and the operating temperature of the battery, the type of battery 50 used (lithium-ion, etc.) must also be taken into account. In fact, the batteries 50 composing the plurality of batteries connected for supplying a power distribution network 55 do not all have the same sensitivities to the ambient temperature. The ranges of value of the state of charge of each battery minimizing the state of aging could therefore be different.

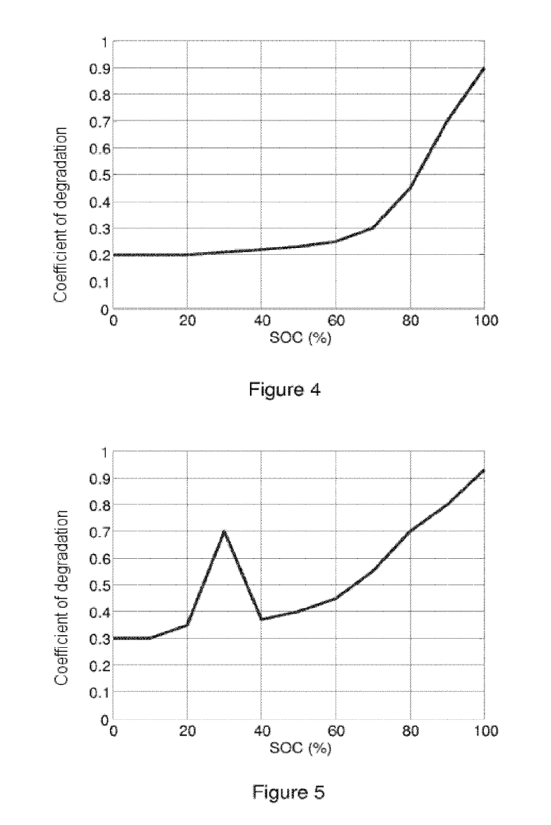

In FIG. 4, it has been observed that when the average operating temperature of the battery 50 is in the range between 10° C. and 25° C., the coefficient of degradation over time, therefore the state of aging of the battery 50, is influenced by the state of charge SOC of the battery 50. More precisely, the higher the state of charge SOC of the battery 50, the higher the coefficient of degradation of the battery. Furthermore, as can be seen in FIG. 4, beyond 70% of the state of charge of the battery, the curve increases very rapidly adopting an exponential shape of curve. In this context, in order to minimize the state of aging of the battery, the state of charge of the battery should remain relatively low. Thus, according to an advantageous disposition, for a range of operating temperature of the battery included between 10° C. and 25° C.:
the first value (SOC1) is equal to 10%, and,
the second value (SOC2) is equal to 70%. In FIG. 5, tests similar to those shown in FIG. 4 have been carried out, but for an average operating temperature of the battery 50 substantially equal to 45° C. In the same manner as for the results shown in FIG. 4, for a range of temperatures included between 10° C. and 25° C., the coefficient of degradation increases rapidly when the state of charge of the battery 50 exceeds 70%. In addition, there is an abrupt increase in the coefficient of degradation for a state of charge SOC of the battery in the range between 20% and 40%. Thus, according to another advantageous disposition, for an operating temperature of the battery substantially equal to 45° C.:
the first value (SOC1) is equal to 50%, and,
the second value (SOC2) is equal to 70%.

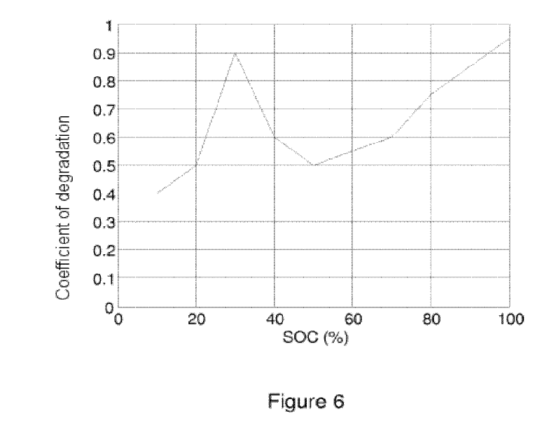

Finally, in FIG. 6, under conditions where the operating temperature of the battery is even higher, with an operating temperature of the battery substantially equal to 55° C., the curve of the coefficient of degradation over time has a similar shape, with an abrupt increase between 20% and 40% of the state of charge of the battery 50 and another increase when the state of charge of the battery 50 exceeds 70%. Thus, according to another advantageous disposition, for an operating temperature of the battery substantially equal to 55° C.:
the first value (SOC1) is equal to 50%, and,
the second value (SOC2) is equal to 70%.

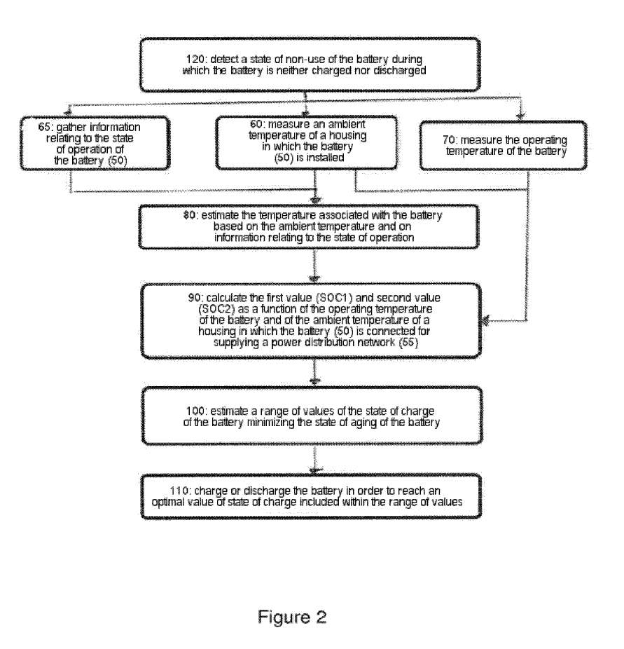

Once the state of charge SOC of the battery 50 calculated as a function of the operating temperature of the battery and/or of the ambient temperature of a housing in which the battery 50 is connected for supplying a power distribution network, here corresponding to the step 90 shown in FIG. 2, it is convenient to translate this state of charge SOC into energy in order to identify the setpoint that needs to be applied to the energy storage system 56. By way of example, for a battery 50 having a capacity equal to 14 KWh, a target range of energy included between 7 kWh and 9.8 KWh that minimizes the state of aging of the battery 50 would be obtained.

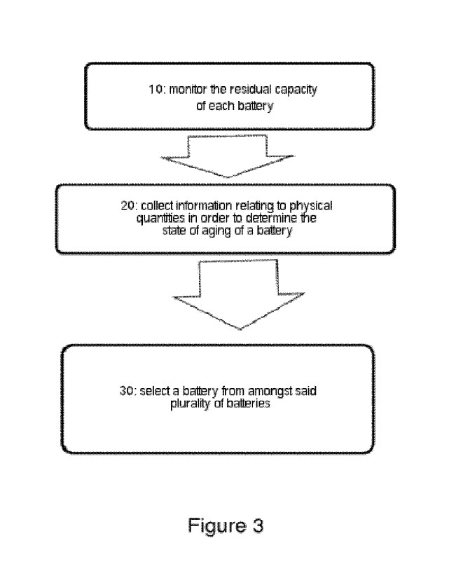

In one embodiment shown in FIG. 3, the management method may also comprise the following preliminary steps:
a step 10 for measuring the state of charge SOC of a plurality of batteries 50,
a step 30 for selecting a battery 50 from amongst said plurality of batteries 50.

This embodiment is advantageous for a plurality of batteries connected together for powering an electrical supply network.

The management method may also comprise a step 20 for collecting information relating to physical quantities for determining the state of aging of a battery 50. This information may be used to decide to scrap a battery 50 if its performance characteristics are insufficient. As regards a commercial performance offered, the minimum level of energy guaranteed to the customer is E_{2nd,MIN}. This minimum level of energy guaranteed to the customer E_{2nd,MIN} is established as a function of the operating temperatures to which the battery 50 is subjected. In practice, it should therefore be verified that the first value SOC1, which is lower than the second value SOC2, allows an energy higher than E_{2nd, MIN} to be supplied. If this is not the case, it needs to be envisioned either to modify the behavior of the stationary storage control system 52 in order to guarantee the guaranteed minimum level of energy E_{2nd,MIN}, for example, by charging up the battery 50 but remaining within the range of values of the state of charge, or to change the battery 50 connected to the plurality of other batteries 50 for another battery 50 disposing of a higher residual capacity.

The stationary storage control system 52 carries out the essential part of the calculations relevant in the framework of the present invention.

1-12. (canceled)

13. A method for managing a state of charge of a battery connected for supplying a power distribution network, the method comprising:
estimating a range of values of said state of charge of the battery minimizing a state of aging of the battery;
charging or discharging the battery so as to reach an optimum value of state of charge included within said range of values; and
prior to the estimating, detecting a state of non-use of the battery during which the battery is neither charged nor discharged.

14. The method for managing a state of charge of a battery as claimed in claim 13, wherein, during the detecting, an expiration of a predetermined period during which the battery is in the state of non-use is detected.

15. The method for managing a state of charge of a battery as claimed in claim 13, wherein said range of values minimizing the state of aging of the battery comprises a first minimum value and a second maximum value which vary as a function of a temperature associated with the battery.

16. The method for managing a state of charge of a battery as claimed in claim 15, wherein the temperature associated with the battery is an operating temperature of the battery.

17. The method for managing a state of charge of a battery as claimed in claim 15, wherein the temperature associated with the battery is an ambient temperature of a housing in which the battery is installed.

18. The method for managing a state of charge of a battery as claimed in claim 17, wherein further comprising:
estimating the temperature associated with the battery based on said ambient temperature and on information relating to an operation of the battery.

19. The method for managing a state of charge of a battery as claimed in claim 16, wherein, for a range of operating temperature of the battery between 10° C. and 25° C.:
the first minimum value is equal to 10%, and,
the second maximum value is equal to 70%.

20. The method for managing a state of charge of a battery as claimed in claim 16, wherein, for an operating temperature of the battery substantially equal to 45° C.:
the first minimum value is equal to 50%, and,
the second maximum value is equal to 70%.

21. The method for managing a state of charge of a battery as claimed in claim 16, wherein, for an operating temperature of the battery substantially equal to 55° C.:
the first minimum value is equal to 50%, and,
the second maximum value is equal to 70%.

22. The method for managing a state of charge of a battery as claimed in claim 13, further comprising prior to the detecting:
measuring the state of charge of a plurality of batteries; and
selecting said battery from said plurality of batteries.

23. The method for managing a state of charge of a battery as claimed in claim 13, further comprising:
determining the state of aging of the battery by collecting information relating to physical quantities of the battery.

24. A system for managing a state of charge of a battery, comprising:
means for estimating a range of values of said state of charge of the battery minimizing a state of aging of the battery;
means for charging or discharging the battery so as to reach an optimum value of state of charge included within said range of values; and
means for detecting, prior to the estimating, a state of non-use of the battery during which the battery is neither charged nor discharged.
